(19) United States
(12) Patent Application Publication
(10) Pub. No.: US 2026/0144405 A1
(43) Pub. Date: May 28, 2026

(54) Combination Air Fryer and Sous Vide Appliance

(71) Applicant: NuWave, LLC, Vernon Hills, IL (US)

(72) Inventors: Jung S. Moon, Long Grove, IL (US); Jong Rok Kim, Seoul (KR); Qing Ping Zeng, Shanwei City (CN)

(21) Appl. No.: 18/958,496

(22) Filed: Nov. 25, 2024

(51) Int. Cl. A47J 37/06; A23L 5/10; A47J 27/00; A47J 27/10; A47J 36/32; F24C 7/08; F24C 15/32; H05B 1/02

(52) U.S. Cl. CPC A47J 37/0641; A23L 5/13; A23L 5/17; A47J 27/004; A47J 27/10; A47J 36/32; F24C 7/087; F24C 15/325; F24C 15/327; H05B 1/0263

(57) ABSTRACT

A combination cooking appliance is disclosed having both an air fryer cooking mode and a sous vide cooking mode, including a method of operation. The appliance includes an outer housing having a series of panels to enclose a cooking chamber having three sidewalls, a top wall, a bottom wall, and an opening at the front panel of the outer housing. A chamber door is positioned over the cooking chamber opening on the front panel. The appliance further includes a water system comprising a water reservoir positioned within the outer housing and capable of holding water, a water basin positioned within the cooking chamber and capable of receiving water, tubing fluidly coupling the water basin to the water reservoir, and a water pump to move water from the water reservoir to the water basin via the tubing during operation of the combination cooking appliance. Finally, the appliance further includes a first heating element positioned within the cooking chamber proximate the top wall, a fan proximate the first heating element for circulating heated air within the cooking chamber, and a second heating element positioned to be in thermal contact with the water basin to heat water received.

### TECHNICAL FIELD OF THE INVENTION

The present disclosure relates to combination cooking appliances. More specifically, the disclosure relates to countertop combination cooking appliances. Most specifically, the disclosed device relates to an electric, multi-purpose, countertop cooking appliance.

### BACKGROUND OF THE INVENTION

There are countless kitchen countertop appliances being sold on television, on the Internet, and in stores, which focus on doing one thing. Specific countertop appliances include convection ovens, toasters, deep fryers, microwaves, pressure cookers, and the like. With a need to have every cooking option available, consumers are running out of counter space and storage space. Having multiple clunky cooking appliances is impractical, especially with a trend toward smaller living spaces such as apartments, condominiums, and tiny houses.

Additionally, appliances which are capable of carrying out two or more cooking methods promote creativity, decrease food waste, and increase cooking efficiency. With the help of the disclosed system and method, consumers can thoroughly cook and crisp their food to perfection by either of two methods: air frying and sous vide.

There are many benefits to each of these cooking methods, so bringing them together in a single appliance will provide users with the best and healthiest food preparation possible. Air frying includes the following benefits:
Healthier—uses less fat and oil than deep frying, which can reduce calories by up to 80% and help with weight management and weight loss;
Preserves nutrients—able to cook food quickly at high temperatures, which helps retain more nutrients than traditional frying methods;
Easier cleanup—much easier to clean than deep fryers;
Less space required—takes up less countertop space;
No lingering smells—will not leave a fried food smell for hours after cooking; and
Safer—does not involve cooking large amounts of oils at high temperatures, making it safter than deep frying.

Sous vide cooking also has many benefits, including:
Consistent results—a precise temperature control prevents over or undercooking;
Retains nutrients—cooking at a low temperature helps preserve nutrients and vitamins in food;
Easier to digest—sous vide breaks down collagen proteins into gelatin, which is easier for the body to absorb;
Increased shelf life—eliminates the risk of contamination during storage, which can double the shelf life of the food;
Reduces waste—food waste is cut by 20-30%;
Versatile—can be used for proteins, vegetables, fruits, and eggs;
Batch cooking—great for batch cooking;
Labor and energy efficient—labor and energy efficient;
Saves time—food can be prepared in advance and then finished just before serving;
Saves money—tougher, less expensive cuts of meat can be cooked to tender perfection; and
Reduces cross-contamination—the high and consistent temperatures used pasteurizes food, which practically eliminates the risk of contamination.

Previous inventions have addressed air frying and sous vide cooking singularly. However, none have combined the concepts. This limits the cooking options available to consumers or requires them to purchase two different appliances. The system and method described here not only cuts down on space taken up by multiple appliances, but it also provides a more economical choice.

Further, by combining multiple functions into a single device, convenience is also improved. Until the invention of the present application, these and other problems in the prior art went either unnoticed or unsolved by those skilled in the art. The present invention provides a unique cooking appliance which performs multiple functions with the associated cooking tools without sacrificing quality, convenience, style, or affordability.

### SUMMARY OF THE INVENTION

There is disclosed herein an improved cooking appliance which avoids the disadvantages of prior cooking systems while affording additional structural and operating advantages.

Generally speaking, a combination cooking appliance is disclosed having both an air fryer cooking mode and a sous vide cooking mode. The appliance comprises an outer housing comprised of a series of panels to enclose a cooking chamber having three sidewalls, a top wall, a bottom wall, and an opening at the front panel of the outer housing. A chamber door is positioned over the cooking chamber opening on the front panel. The appliance further includes a water system comprising a water reservoir positioned within the outer housing and capable of holding water, a water basin positioned within the cooking chamber and capable of receiving water, tubing fluidly coupling the water basin to the water reservoir, and a water pump to move water from the water reservoir to the water basin via the tubing during operation of the combination cooking appliance. Finally, the appliance further includes a first heating element positioned within the cooking chamber proximate the top wall, a fan proximate the first heating element for circulating heated air within the cooking chamber, and a second heating element positioned to be in thermal contact with the water basin to heat water received.

In specific embodiments, the combination appliance further comprises a plurality of negative temperature coefficient (NTC) thermistors positioned within the cooking chamber, including a guard to cover at least one of the plurality of NTC thermistors. Preferably, one of the plurality of NTC thermistors is positioned within the water basin, one of the plurality of NTC thermistors is positioned proximate the first heating element, and two of the plurality of NTC thermistors are positioned on one of the three sidewalls of the cooking chamber.

In other specific embodiments, the appliance comprises a humidity vent tube having a first end positioned in the cooking chamber and a second end positioned on the outer housing. The water system further comprises a water release tube to direct any excess water to the second heating element.

In still other specific embodiments of the combination cooking appliance, the water reservoir comprises a water tank and a fixed channel positioned within the outer housing above the cooking chamber, wherein the water tank is configured to slidably move along the fixed channel and out an opening in the outer housing. The water tank preferably comprises a coupler to friction fit within a recess of the fixed channel to interface with the tubing connected to the recess of the fixed channel.

The present disclosure also describes a method for operation of embodiments of the above combination cooking appliance. The disclosed method comprises the steps of placing food to be cooked within the cooking chamber, activating the first heating element and the fan to raise the temperature in the cooking chamber, activating the second heating element to raise the temperature in the water basin, and activating the pump to deliver water from the reservoir to the basin.

In specific embodiments, the method further comprises controlling the water pump on/off time as follows:
pumping water from the water reservoir to the water basin at a rate of one second on time to 40 seconds off time when a temperature at the lower NTC thermistor is within a range of 75° C. to 90° C.;
lowering the off time of the pumping water to 30 seconds when the temperature at the lower NTC thermistor is within a range of 91° C. to 100° C.;
lowering the off time of the pumping water to 20 seconds when the temperature at the lower NTC thermistor is within a range of 101° C. to 110° C.;
lowering the off time of the pumping water to 10 seconds when the temperature at the lower NTC thermistor is within a range of 111° C. to 125° C.; and
lowering the off time of the pumping water to 5 seconds when the temperature at the lower NTC thermistor is within a range of 126° C. to 135° C.

These and other aspects of the invention may be understood more readily from the following description and the appended drawings.

### BRIEF DESCRIPTION OF THE DRAWINGS

For the purpose of facilitating an understanding of the subject matter sought to be protected, there are illustrated in the accompanying drawings, embodiments thereof, from an inspection of which, when considered in connection with the following description, the subject matter sought to be protected, its construction and operation, and many of its advantages should be readily understood and appreciated.

FIG. 1 is a general schematic illustrating an embodiment of the disclosed appliance;

FIG. 2 is a front view of an embodiment of the disclosed appliance showing the cooking chamber and open door;

FIG. 3A is a side view of an embodiment of the disclosed appliance showing a side panel removed and an interior cavity for control circuitry and the cooking chamber;

FIG. 3B is a close up of the spring-biasing mechanism for the hinged door covering the open end of the cooking chamber;

FIG. 4 is a rear view of an embodiment of the disclosed appliance showing a rear panel having air ventilation openings and an air intake vent;

FIG. 5 is a another side view of an embodiment of the disclosed appliance with a side panel removed to show the water pump and tubing;

FIG. 6 is a top view of an embodiment of the disclosed appliance with the top panel removed to show the water reservoir, control circuitry, and fan components;

FIG. 7 is a partial side view illustrating an embodiment of the sliding water tank and channel of the water reservoir;

FIG. 8 is partial top view of the sliding water tank and channel of the water reservoir shown in FIG. 7;

FIG. 9 is another partial top view showing the channel of the water reservoir;

FIG. 10A is a partial side view of an embodiment of the water tank showing the rear portion including a coupler;

FIG. 10B is a partial side view of the water tank of FIG. 10A showing the front portion including the tank door;

FIG. 11 is a front perspective view showing the water tank of FIGS. 10A and 10B;

FIG. 12 is a partial top view of the interior cavity of the disclosed appliance showing control circuitry, the fan motor, and a steam vent opening;

FIG. 13 is another top view of an embodiment of the disclosed appliance with a top panel removed to show the interior cavity;

FIG. 14 is partial view of the interior cavity showing the steam vent tube;

FIG. 15 is couple images showing an embodiment of the steam vent cap;

FIG. 16 is a close-up view of a top surface of the cooking chamber showing an opening for the steam vent;

FIG. 17A is a front view of the cooking chamber interior highlighting an embodiment of the NTC guard in the upper right corner;

FIG. 17B is a close-up of the NTC guard shown in FIG. 17A;

FIG. 18 is a close-up of an embodiment of the water basin in a bottom wall of the cooking chamber;

FIG. 19 is another close-up of the interior of the cooking chamber;

FIG. 20 is a close-up of an embodiment of the cooking chamber light; and

FIG. 21 is a close-up of the cooking chamber top wall showing the first (top) heating element and associated fan.

### DETAILED DESCRIPTION OF THE INVENTION

While this invention is susceptible of embodiments in many different forms, there is shown in the drawings and will herein be described in detail at least one preferred embodiment of the invention with the understanding that the present disclosure is to be considered as an exemplification of the principles of the invention and is not intended to limit the broad aspect of the invention to any of the specific embodiments illustrated.

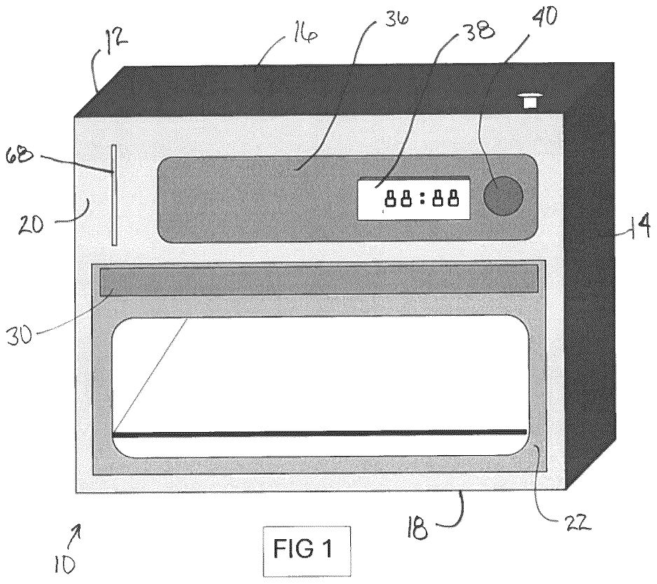

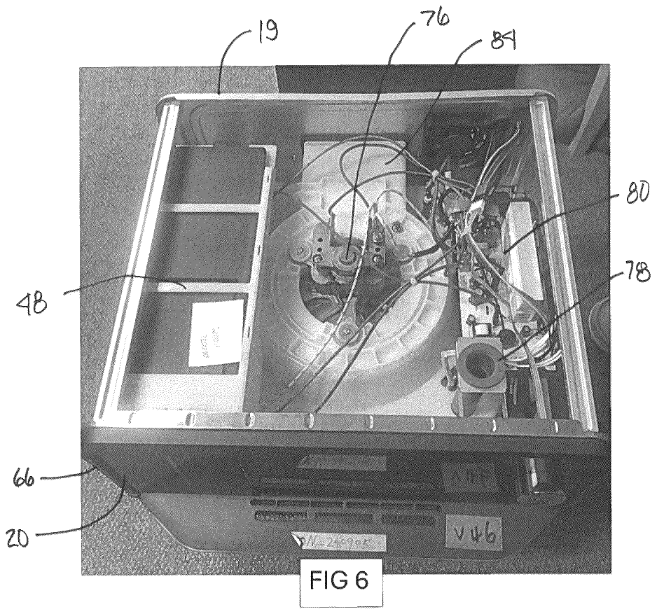

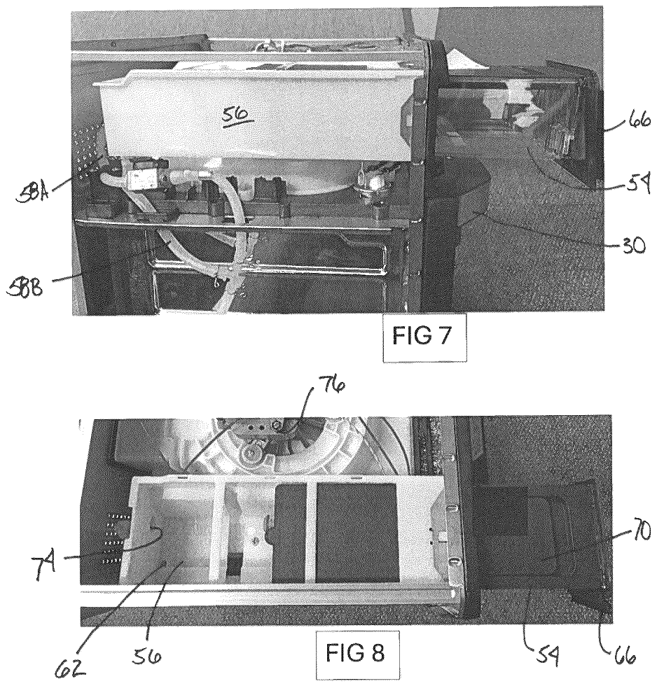

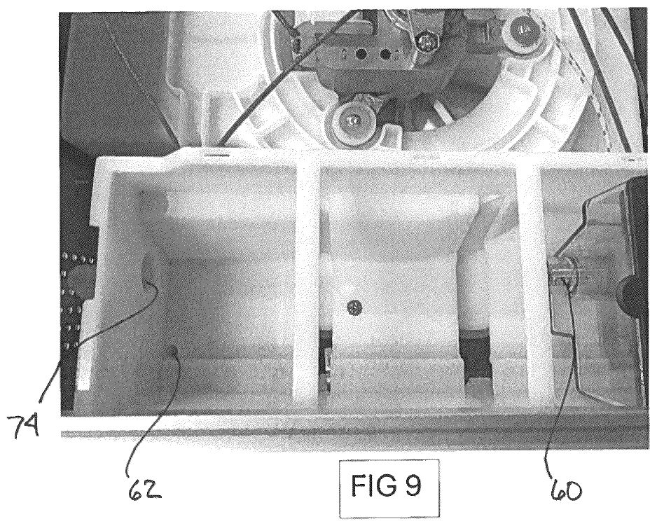

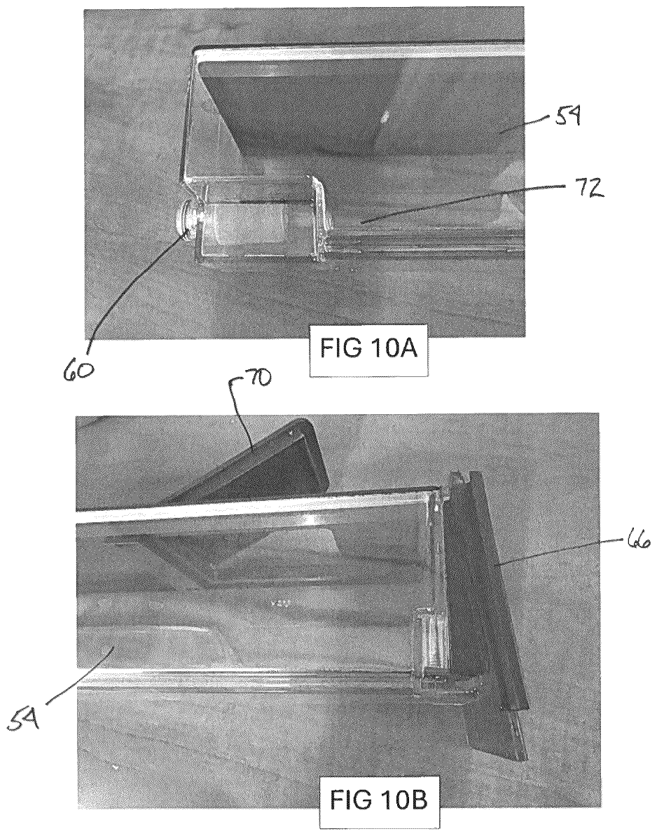

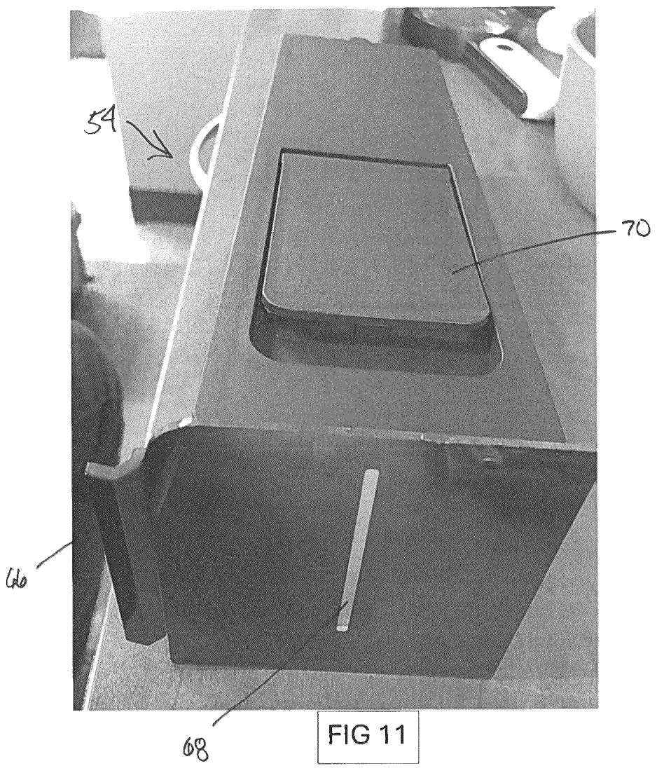

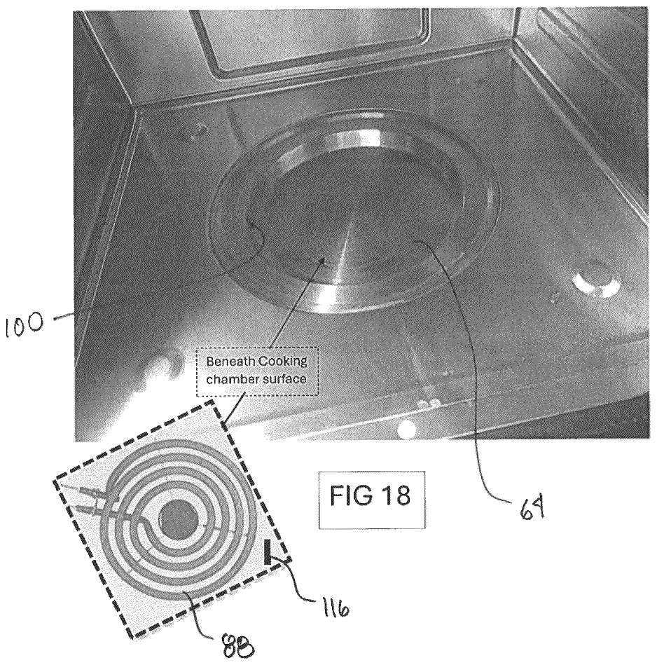

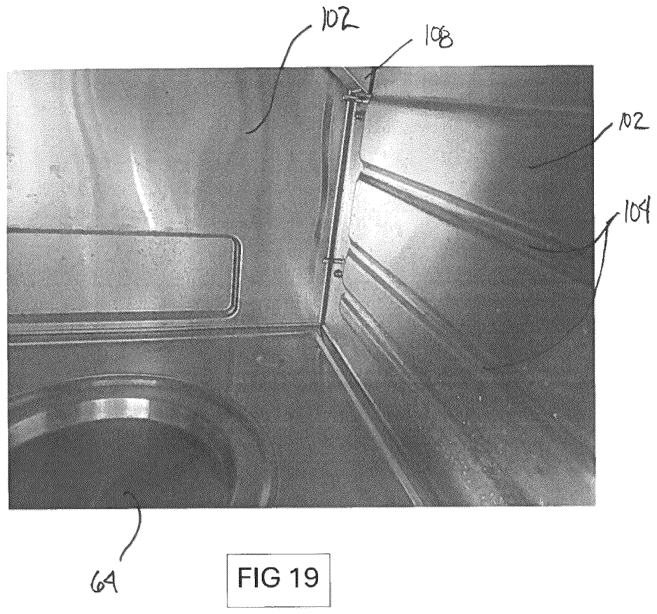

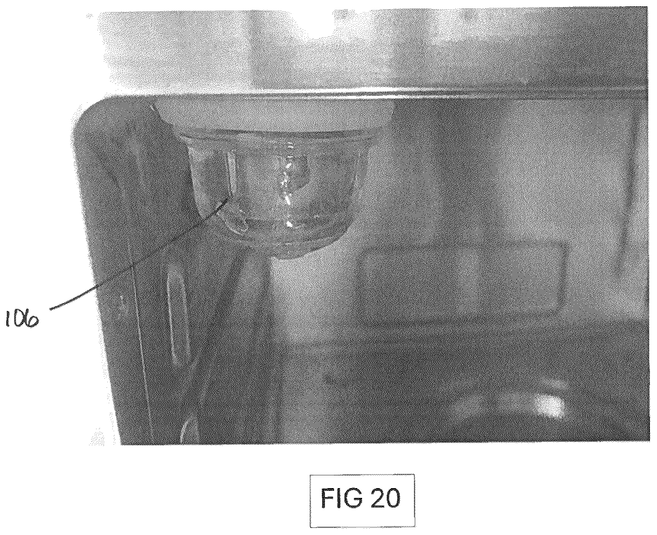

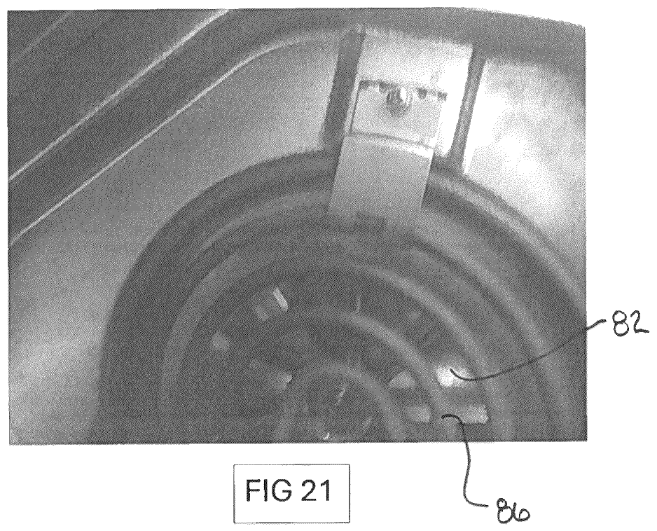

Referring to FIGS. 1-21, there is illustrated at least one preferred embodiment of, and various components of a combination sous vide and air fryer appliance, generally designated by the numeral 10. The specifically illustrated appliance 10 is for a countertop cooking appliance. However, while all the embodiments illustrated are directed to a countertop model, it should be understood that the principles of the invention can be more broadly applied to larger or even smaller appliances and systems.

A simplistic illustration of appliance 10 is shown in FIG. 1. The illustrated appliance 10 is comprised of an outer housing 12 having three connected sidewalls 14, a top panel 16, a bottom panel 18, and a front panel 20 including a hinged door 22. Within the outer housing 12 is situated cooking chamber 24. Also positioned within the outer housing 12 of appliance 10 are several components which function to provide a combination air fryer cooking system and a sous vide cooking system, as explained in detail below.

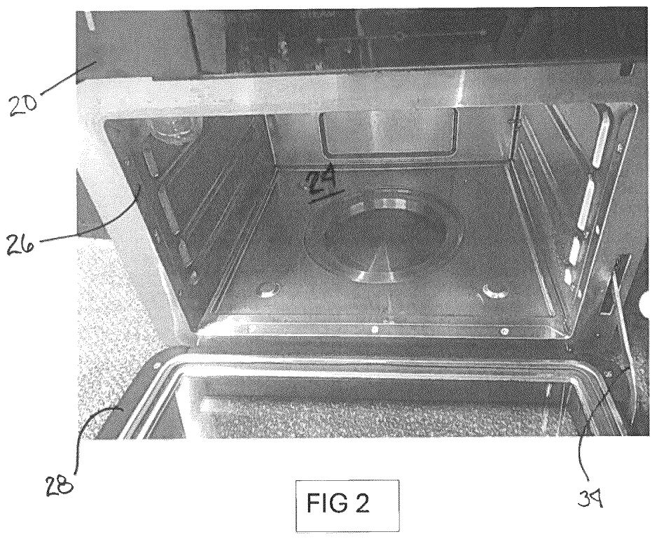

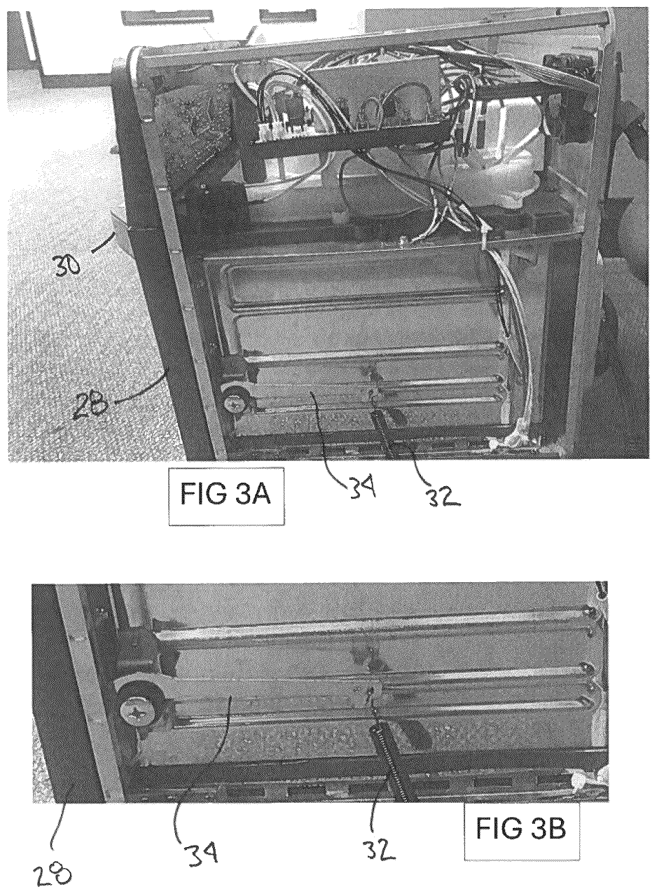

The front panel 20 of the outer housing 12 includes an opening 26 into the cooking chamber 24. As illustrated in FIG. 2, the opening 26 is covered by a hinged door 28 which seals against a periphery of the opening to help maintain heat within the cooking chamber 24. A handle 30 on the door 28 and a spring mechanism 32 (see FIGS. 3A and 3B) biasing an arm 34 connected to the door 28 facilitates both opening and closing of the hinged door 28. Above the handle 30 is a control panel 32, including digital display 34 and control knob 40. The control panel 36 provides user input (e.g., temperature, cooking time, etc.) and displays the status of cooking parameters, as is well known in the art.

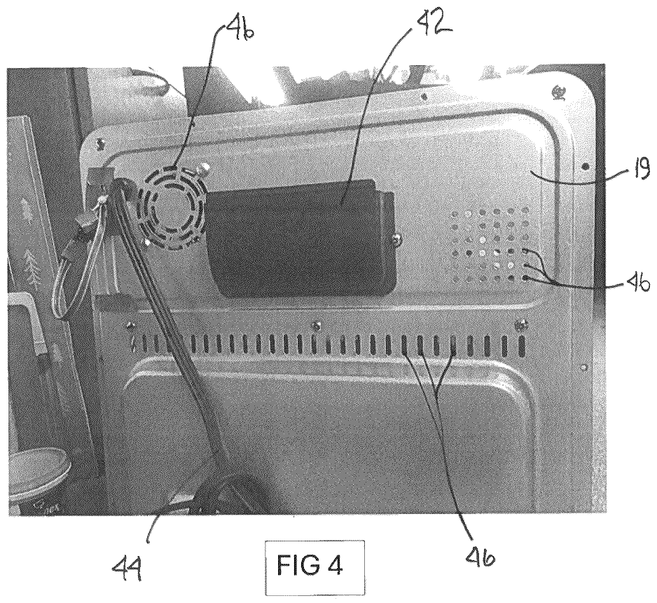

Referring now to FIG. 4, the rear panel 19 of appliance 10 includes an air intake vent 42, a power cord 44, and air circulation openings 46 to coincide with specific electronic components within the housing 12. The metal rear panel 19 helps shield internal components from excessive heat, and also acts as a heat sink to draw heat away from fragile electronic components and allow cooling via the air openings 46.

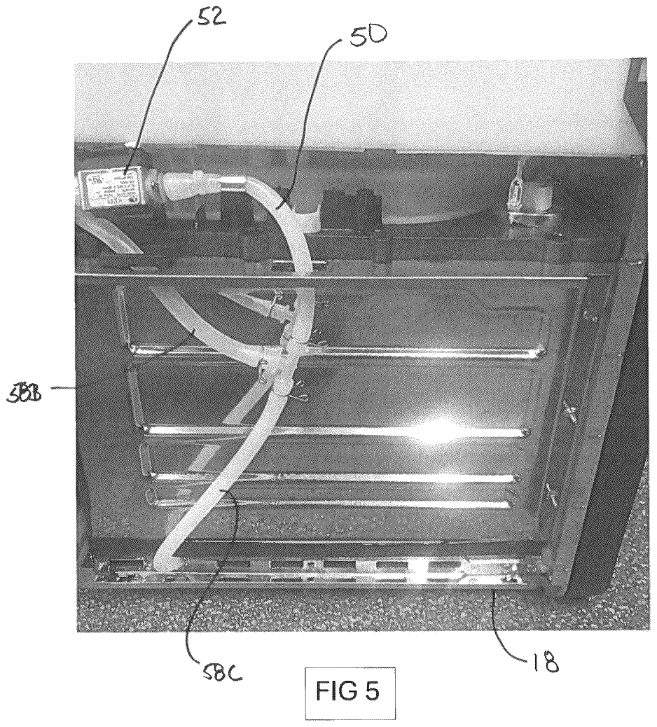

FIGS. 5-15 provide a look inside the outer housing 12 of appliance 10—i.e., the interior cavity—by removing the side and top panels. At the top of the interior cavity is a water reservoir 48 connected by tubing 50 to a water pump 52. The reservoir 48 is comprised of a tank 54 which slides into a channel 56 fixed within the interior cavity. There are two water delivery tubes from the reservoir 48. The first tube 58A extends from a side of the reservoir 48 is connected to the water pump 52. In use, the pump 52 draws water directly from the tank 54 via a coupler 60. The second tube 58B is connected by one end to a bottom opening 62 in the channel 56 and the opposite end connects to the first delivery tube 58A. This allows any leaked water from the tank 54 to be captured within the channel 56 and gravity fed into the second tube 58B to be routed into the final portion of tubing 50. The final tube portion 58C delivers water from both the first and second tubes, 58A and 58B, to the water basin 64 in the cooking chamber 24, as described in greater detail below.

FIGS. 7-11 illustrate aspects of the water reservoir 48. As noted, the reservoir 48 is comprised of a water tank 54 which slides through an opening in the front panel 20 to be seated within channel 56 fixed within the interior cavity of the appliance 10. The tank 54 has a side handle 66 on a front face to facilitate sliding of the tank 54 within the channel 56. A water level indicator 68 on the front face also allows easy determination of a how much water is within the tank 54 without removal. To fill the tank 54 it must first be pulled sufficiently out of the channel 56 to allow a door 70 on the top of the tank 54 to be opened. Water can then be poured into the tank 54 and the tank 54 returned to an engaged position within the channel 56. At the back of the tank 54 is the coupler 60 having a short tube 72 on the inside of the tank 54. A filter 74 may also be attached to the coupler 60 and used to prevent sediment or other matter from entering the water delivery tubing 50. When in an engaged position, the tank 54 is completely retracted into the channel 56 and the coupler 60 friction fits within a recess 74 in a back wall of the channel 56. The coupler 60 seals within the recess 74 to prevent leakage. The first tube 58A is connected to an opposite side of the recess 74 such that water can be directly drawn from the tank 54 during operation of the water pump 52.

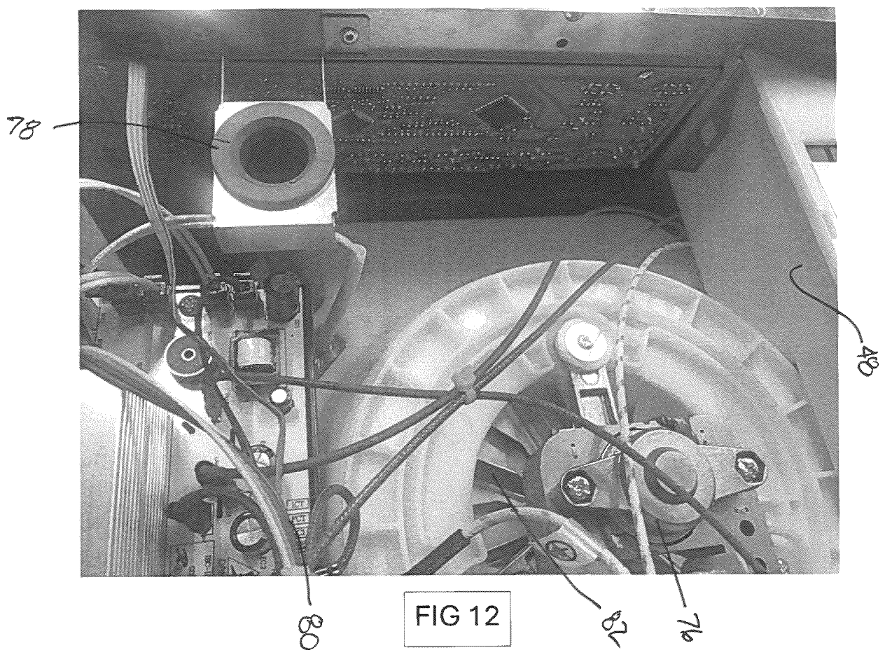

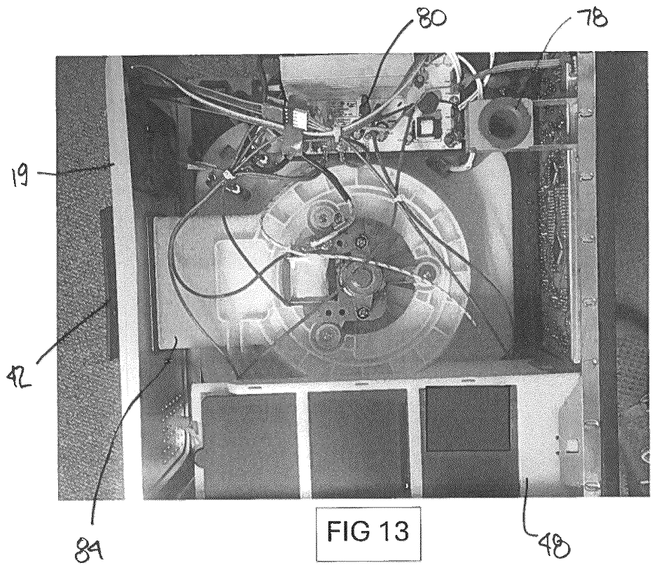

Adjacent the reservoir 48 within the interior cavity, a fan motor 76, a humidity vent 78, and control circuitry 80 can be seen in FIGS. 12 and 13. The fan motor 76 is connected to a fan 82 (see FIG. 21) and operates to draw air into duct 84 from the air intake vent 42 on rear panel 19 and deliver the air to a first (or upper) heating element 86 to be heated. The control circuitry 80 is programmed to control operation of the fan 82, heating elements 86, 88, water pump 52, and input control panel 36. Specifics of the operating parameters are detailed below.

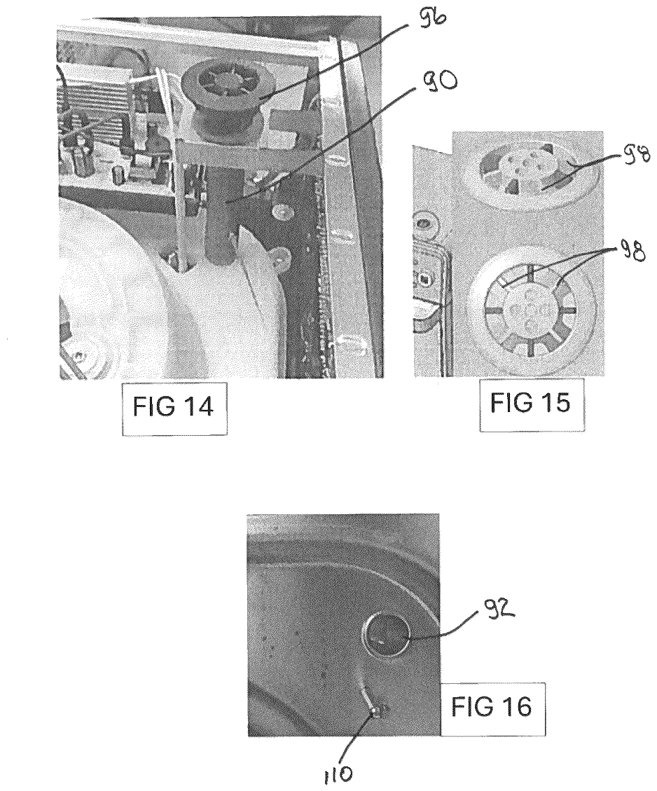

The humidity vent 78 is best illustrated in FIGS. 14 and 15. The vent 78 is comprised of a long tube 90 which has a first opening 92 on a top surface of the cooking chamber 24 (see FIG. 16) and a second opening 94 on the top panel 16 of the outer housing 12. The second opening 94 may include a fluted passage 96 with ribs 98 to properly dissipate the extremely hot steam being emitted.

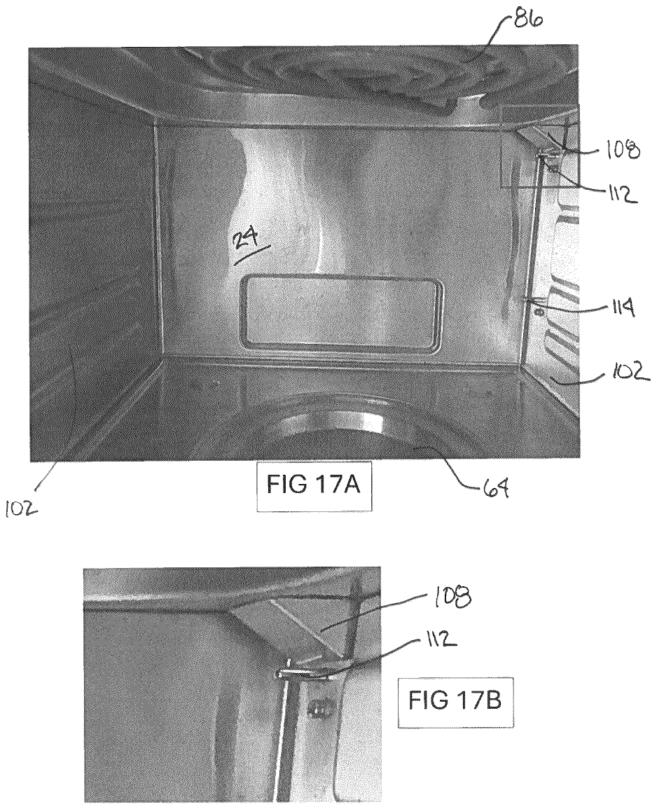

Referring now to FIGS. 17-21, the cooking chamber 24 can be more readily described and understood. The cooking chamber 24 is situated within the outer housing 12 with access through the hinged door 28 on the front panel 20 (see FIG. 2). The interior is made of stainless steel or other suitable metal. At the base of the cooking chamber 24 is formed the water basin 64. Preferably, the water basin 64 is formed into the base surface, but it may be a removable basin as well. The lower (or bottom) heating element 88 is preferably positioned beneath the base in thermal contact with the water basin 64. The water tubing 50 extends down the interior cavity to a small opening 100 within the water basin 64. Water from the reservoir 48 is pumped through the tubing 50 to enter the basin 64 through the opening 100. The heating element 88 is controlled, as necessary, to heat water within the basin 64 for sous vide cooking.

As shown, the sidewalls 102 of the cooking chamber 24 have formed tray guides 104 to allow food to be elevated within the chamber 24 during cooking. The top surface of the cooking chamber also includes the upper electric heating element 86 positioned just below the fan 82, as previously described. The fan 82 and upper heating element 86 are controlled, as necessary, to create heated convection air flow for air fryer cooking. The upper heating element 86 and fan 82 may also be used in sous vide cooking. A sealed lighting fixture 106 is preferably positioned on the top surface of the cooking chamber 24 and may be separately controlled at the input panel 36.

The cooking chamber 24 includes at least four negative temperature coefficient (NTC) thermistors positioned therein. A first NTC 110 is positioned proximate the upper heating element 86. Second and third NTCs 112 and 114 are positioned on a sidewall of the cooking chamber 24, preferably in vertical alignment at a high point and a lower point of the chamber. A water guard 108 is positioned above the second and third NTCs 112 and 114. The water guard 108 is a slanted metal structure used to prevent water droplets from dripping onto the NTCs and causing inaccurate temperature readings. Finally, the fourth NTC 116 is positioned below the water basin 64 proximate the lower heating element 88. These NTCs are all connected to the control circuitry 80 for careful and exacting control of cooking temperatures and time.

### Operation of Appliance

The disclosed appliance 10 is capable of operation as both an air fryer and a sous vide system. The front panel 20 of the outer housing 12 includes a control panel 36 which allows for user input of cooking parameters. Once the appliance is plugged in to a power source, the control panel 36 will allow for programs to be entered using a touch screen 38 and knob 40. Preprogrammed cooking settings may also be provided. The user can input parameters for both the sous vide and air fryer cooking.

For air frying, time and temperature are set at the control panel 36. Once the parameters are entered, the upper heating element 86 is activated along with the fan 80 (approx. 2600 rpm) to begin heating the cooking chamber 24. The four NTC thermistors 110/112/114/116 provide feedback to the control circuitry 80 regarding the cooking chamber temperature. An audible and/or visual alert will occur when the set temperature is achieved. After food is placed into the cooking chamber 24, the desired temperature will be maintained for the entered cooking time. An audible and/or visual alert will again sound when the cooking time is complete.

For sous vide cooking, time and temperature are set at the control panel 36. Once the parameters are entered, the bottom heating element 88 is activated along with the water pump 52. Water is added from the reservoir 48 to the basin 64 where it is heated by the bottom heating element 88 to create steam within the cooking chamber 24. The upper heating element 86 is also used to achieve the desired cooking chamber temperature. The four NTC thermistors 110/112/114/116 provide feedback to the control circuitry 80 regarding the cooking chamber temperature. An audible and/or visual alert will occur when the set temperature is achieved. After the food is placed into the cooking chamber 24, the desired temperature will be maintained for the entered cooking time.

During sous vide cooking mode, the humidity (i.e., steam) of the chamber is controlled by the power of the two heating elements. The power ratio of the two heating elements is as shown in TABLE 1 below:

TABLE

| Top Heater (1700 W-max) | | Steam Heater (1200 W-max) | | Total |
|---|---|---|---|---|
| Power (%) | Power (W) | Power (%) | Power (W) | Power (W) |
| 10 | 500 | 90 | 1200 | 1700 |
| 15 | 560 | 85 | 1140 | 1700 |
| 20 | 620 | 80 | 1080 | 1700 |
| 25 | 680 | 75 | 1020 | 1700 |
| 30 | 740 | 70 | 960 | 1700 |
| 35 | 800 | 65 | 900 | 1700 |
| 40 | 860 | 60 | 840 | 1700 |
| 45 | 920 | 55 | 780 | 1700 |
| 50 | 980 | 50 | 720 | 1700 |
| 55 | 1040 | 45 | 660 | 1700 |
| 60 | 1100 | 40 | 600 | 1700 |
| 65 | 1160 | 35 | 540 | 1700 |
| 70 | 1220 | 30 | 480 | 1700 |
| 75 | 1280 | 25 | 420 | 1700 |
| 80 | 1340 | 20 | 360 | 1700 |
| 85 | 1400 | 15 | 300 | 1700 |
| 90 | 1460 | 10 | 240 | 1700 |

As mentioned previously, the temperature in the cooking chamber 24 is relayed by the NTCs to the control circuitry 80. For temperatures in excess of 300° F., the upper NTC 110 is controlling. For temperatures below 300° F., the second, third, and fourth NTCs, 112, 114, and 116, are controlling. The latter control depends on the humidity of the cooking chamber 24. When the humidity is less than 30%, the second and third NTCs 112, 114 are controlling, while the fourth NTC 116 is controlling when the humidity is over 30%. For temperature accuracy and stability, the fan 82 may run at low speed (approx. 1200 rpm).

At start up for sous vide cooking, when the bottom NTC 116 reaches 75° C. the water pump 52 is activated for approximately 5-15 seconds, most preferably 11 seconds, to deliver water to the water basin 64. As the NTC 116 records temperature between 75-90° C., the water pump 52 operates at an “on/off” cycle of 1:40 seconds. That is, the pump 52 is on for 1 second and then off for 40 seconds. When the temperature passes 90° C., the off time is shortened to 30 seconds. At 100° C. the off time drops to 20 seconds, then 10 seconds at 110° C., and 5 seconds at 125° C. If the temperature reaches 135° C., the water pump 52 operates for 15 seconds and then switches to a 1:3 second “on/off” cycle and the bottom heating element 88 is turned off. This will also trigger an alert (visual and/or audible) indicating the need to “add water” to the water tank 54. An audible and/or visual alert will also sound when the cooking time is complete.

The matter set forth in the foregoing description and accompanying drawings is offered by way of illustration only and not as a limitation. While particular embodiments have been shown and described, it will be apparent to those skilled in the art that changes and modifications may be made without departing from the broader aspects of applicants' contribution. The actual scope of the protection sought is intended to be defined in the following claims when viewed in their proper perspective based on the prior art.

What is claimed is:

1. A combination cooking appliance comprising:
an outer housing comprised of two side panels, a rear panel, a top panel, a bottom panel, and a front panel;
a cooking chamber positioned within the outer housing and having three sidewalls, a top wall, a bottom wall, and an opening at the front panel of the outer housing;
a chamber door positioned to cover the cooking chamber opening on the front panel;
a water system comprising:
a water reservoir positioned within the outer housing and capable of holding water;
a water basin positioned within the cooking chamber and capable of receiving water;
tubing fluidly coupling the water basin to the water reservoir; and
a water pump to move water from the water reservoir to the water basin via the tubing during operation of the combination cooking appliance;
a first heating element positioned within the cooking chamber proximate the top wall;
a fan proximate the first heating element for circulating heated air within the cooking chamber; and
a second heating element positioned to be in thermal contact with the water basin to heat water received.

2. The combination cooking appliance of claim 1, further comprising a plurality of negative temperature coefficient (NTC) thermistors positioned within the cooking chamber.

3. The combination cooking appliance of claim 2, further comprising a guard to cover at least one of the plurality of NTC thermistors.

4. The combination cooking appliance of claim 2, wherein one of the plurality of NTC thermistors is positioned within the water basin.

5. The combination cooking appliance of claim 2, wherein one of the plurality of NTC thermistors is positioned proximate the first heating element.

6. The combination cooking appliance of claim 2, wherein two of the plurality of NTC thermistors are positioned on one of the three sidewalls of the cooking chamber.

7. The combination cooking appliance of claim 2, comprising four NTC thermistors.

8. The combination cooking appliance of claim 1, further comprising a humidity vent tube having a first end positioned in the cooking chamber and a second end positioned on the outer housing.

9. The combination cooking appliance of claim 1, wherein the water system further comprises a water release tube to direct any excess water to the second heating element.

10. The combination cooking appliance of claim 1, wherein the fan runs at a speed in the range of 800 to 1500 rpms when the cooking chamber temperature is below 250° F. and at a speed in the range of from 2000 to 3000 rpms when the cooking chamber temperature is above 250° F.

11. The combination cooking appliance of claim 1, wherein the water reservoir comprises a water tank and a fixed channel positioned within the outer housing above the cooking chamber, wherein the water tank is configured to slidably move along the fixed channel and out an opening in the outer housing.

12. The combination cooking appliance of claim 11, wherein the water tank comprises a coupler to friction fit within a recess of the fixed channel to interface with the tubing connected to the recess of the fixed channel.

13. A method of cooking with an appliance having:
an outer housing comprised of two side panels, a rear panel, a top panel, a bottom panel, and a front panel;
a cooking chamber positioned within the outer housing and having three sidewalls, a top wall, a bottom wall, and an opening at the front panel of the outer housing;
a chamber door positioned over the cooking chamber opening on the front panel;
a water system comprising:
a water reservoir positioned within the outer housing and capable of holding water;
a water basin positioned within the cooking chamber and capable of receiving water;
tubing fluidly coupling the water basin to the water reservoir; and
a water pump to move water from the water reservoir to the water basin via the tubing during operation of the combination cooking appliance;
a first heating element positioned within the cooking chamber proximate the top wall;
a fan proximate the first heating element for circulating heated air within the cooking chamber; and
a second heating element positioned to be in thermal contact with the water basin to heat water received; an outer housing comprised of two side panels, a rear panel, a top panel, a bottom panel, and a front panel;
the method comprising:
placing food to be cooked within the cooking chamber;
activating the first heating element and the fan to raise the temperature in the cooking chamber;
activating the second heating element to raise the temperature in the water basin;
activating the pump to deliver water from the reservoir to the basin.

14. The method of claim 13, wherein the cooking appliance further comprises a plurality of negative temperature coefficient (NTC) thermistors positioned within the cooking chamber.

15. The method of claim 14, further comprising covering at least one of the plurality of NTC thermistors.

16. The method of claim 14, further comprising positioning one of the plurality of NTC thermistors within the water basin as a lower NTC thermistor.

17. The method of claim 16, further comprising positioning one of the plurality of NTC thermistors proximate the first heating element as an upper NTC thermistor.

18. The method of claim 17, further comprising positioning two of the plurality of NTC thermistors on one of the three sidewalls of the cooking chamber as middle NTC thermistors.

19. The method of claim 18, further comprising controlling the water pump on/off time as follows:
pumping water from the water reservoir to the water basin at a rate of one second on time to 40 seconds off time when a temperature at the lower NTC thermistor is within a range of 75° C. to 90° C.;
lowering the off time of the pumping water to 30 seconds when the temperature at the lower NTC thermistor is within a range of 91° C. to 100° C.;
lowering the off time of the pumping water to 20 seconds when the temperature at the lower NTC thermistor is within a range of 101° C. to 110° C.;
lowering the off time of the pumping water to 10 seconds when the temperature at the lower NTC thermistor is within a range of 111° C. to 125° C.; and
lowering the off time of the pumping water to 5 seconds when the temperature at the lower NTC thermistor is within a range of 126° C. to 135° C.

20. The method of claim 19, further comprising lowering the off time to 3 seconds if the lower NTC thermistor is above 135° C.

21. The method of claim 20, further comprising deactivating the second heating element when the lower NTC thermistor is above 135° C. for a time greater than 60 seconds.

22. The method of claim 21, activating a warning to indicate an empty water reservoir when the lower NTC thermistor is above 135° C. for greater than 60 seconds.
